(19) United States
(12) Patent Application Publication
(10) Pub. No.: US 2020/0184047 A1
(43) Pub. Date: Jun. 11, 2020

(54) AUTHENTICATE A FIRST AND SECOND USER

(71) Applicant: HEWLETT-PACKARD DEVELOPMENT COMPANY, L.P., Spring, TX (US)

(72) Inventors: Alexander Thayer, Palo Alto, CA (US); Mithra Vankipuram, Palo Alto, CA (US)

(21) Appl. No.: 16/605,198

(22) PCT Filed: Aug. 28, 2017
(86) PCT No.: PCT/US2017/048901

§ 371 Date: Oct. 14, 2019

(51) Int. Cl. G06F 21/31; H04W 12/06; H04W 4/80; H04W 4/021; H04W 12/08; H04L 29/06

(52) U.S. Cl. CPC G06F 21/31; H04W 12/06; H04L 63/0853; H04W 4/021; H04W 12/08; H04W 4/80

(57) ABSTRACT

Examples disclosed herein relate to authenticating a first and second user. For example, a processor may authenticate a first user to access at least one of a device and a location and identify a second user located within an authentication zone. The processor may trigger an authentication process for the second user based on the identification and output information indicating whether the second user is authenticated.

### BACKGROUND

An authentication process may be performed to determine whether to allow access to a user. For example, a user may scan a badge or provide a password that is used to authenticate a user. If authenticated, the user may be granted access, such as by a door automatically unlocking and allowing a user to enter a restricted location.

### BRIEF DESCRIPTION OF THE DRAWINGS

The drawings describe example embodiments. The following detailed description references the drawings, wherein:

FIG. 1 is a block diagram illustrating one example of a computing system to authenticate a first and second user.

FIG. 2 is a flow chart illustrating one example of a method to authenticate a first and second user.

FIG. 3 is a diagram illustrating one example of authenticating a first and second user.

FIG. 4 is a flow chart illustrating one example of authenticating multiple users.

### DETAILED DESCRIPTION

In one implementation, a processor authenticates users in a communal manner such that an authentication process for a second user is triggered if the second user is determined to be located within an area associated with a likelihood that access of an authenticated first user provides access to the second user. The processor may output information about the result of the authentication process for the second user. As an example, a first user may be authenticated to open a door to access a restricted location. The authentication of the first user may trigger an authentication process for a second user within a vicinity of the door. For example, the processor may determine that the distance between the second user and the door is less than a threshold related to a likelihood of the second user to enter the doorway if opened by the first user. A notification may be generated to indicate the result of the authentication process. The notification may be provided to the first user and/or the second user. For example, a notification maybe created on a display that is viewable by people in a surrounding area, such as a sign display near a door. In one implementation, a notification may be provided to individual user devices, such as a notification provided by a wearable device of the first user to alert the first user that the second user is not authenticated.

A communal authentication process may be used to restrict access to a device or location in cases where the authentication of one user affects the access of another user. A notification may be generated to alert the user being authenticated and/or other users in the vicinity to encourage users not to provide access to an unauthenticated user. For example, “tailgating” where an authorized user holds a door open for another user that may not be authorized may be less likely where users are aware of the authentication status of other users. An unauthorized user following an authenticated user may be prevented from accessing a location or device by other users aware of the unauthorized status.

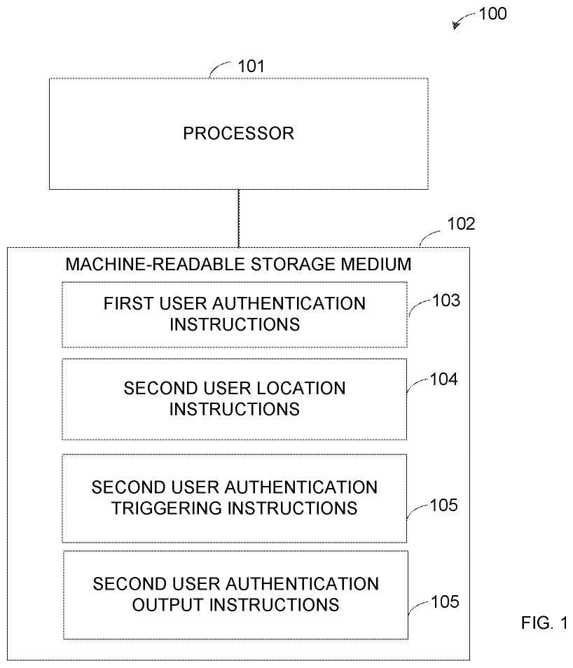

FIG. 1 is a block diagram illustrating one example of a computing system to authenticate a first and second user. For example, the computing system 100 may authenticate users in a communal manner such that if a first user is authenticated, an authentication process is triggered for other users within an authentication zone of a restricted location and/or device to which the first user is authenticated. The computing system 100 may be associated with a restricted location or device, such as a restricted access room or piece of lab equipment. The computing system 100 may authenticate users for a set of restricted locations and/or devices associated with an entity, such as a company, or may provide authentication services for multiple entities. The computing system 100 includes a processor 101 and a machine-readable storage medium 102.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 includes first user authentication instructions 103, second user location instructions 104, second user authentication triggering instructions 105, and second user authentication output instructions 106.

The first user authentication instructions 103 may include instructions to authenticate a first user to access at least one of a device and location. The authentication process may be triggered by any suitable event, such as detecting a user wearable within a vicinity of a location or detecting a user scanning a badge. The authentication process may result in authentication of the first user. The location may be, for example, a room, building, or other restricted access space. The device may be, for example, a piece of equipment, a computer, or other restricted device. In one implementation, there may be multiple levels of access, such as a restricted location including equipment that requires additional authentication.

The second user location instructions 104 may include instructions to locate a second user within a threshold vicinity of at least one of the first user, the location, and the device. The threshold vicinity may be a stored threshold distance related to a likelihood that a user could access the restricted location or device if another user is provided access. In one implementation, the processor 101 determines the dimensions of the threshold vicinity based on the restricted location and/or device and the surrounding area.

In one implementation, the computing system 100 includes a sensor to determine the location of the second user. The sensor may be associated with a device of the second user, such as a mobile device or wearable of the second user or may be a sensor associated with the restricted location or device, such as a camera above a restricted access door.

The second user authentication triggering instructions 105 may include instructions to trigger an authentication process for the second user in response to the authentication of the first user. For example, the second user may be determined to be within a threshold distance of the user, location, and/or device, and an authentication process may be triggered for the second user if the first user is authenticated. In one implementation, an authentication process is triggered for multiple users within a threshold distance if a first users is authenticated.

In one implementation the authentication process for the second user is based on information from the first user related to the second user. For example, the first user may be able to vouch for the first user, such as by taking responsibility for escorting the second user or by providing additional information not stored in a data storage used for the authentication process.

The authentication process may involve any suitable authentication method. In one implementation, the computing system 100 includes a storage to store authentication rules, such as related to user training level, authentication time period, user role, and/or user relationship. For example, the authentication process may involve authenticating the identity of the second user and comparing information about the user to the stored authentication rules to determine if the second users should be allowed access.

The second user authentication output instructions 106 may include instructions to output information indicating whether the second user is authenticated, such as by storing, displaying, or transmitting the information. An alert may be generated related to the result. For example, a visible or audible notification may be generated. In one implementation, the authentication result is output to a device such that the information is received by multiple users. For example, an image of authenticated people may be displayed on a sign near a restricted entrance.

In one implementation, the result of the authentication process may be transmitted to multiple user devices. For example, the result of the authentication may be transmitted to a mobile and/or wearable device of the first and/or second user. In one implementation, an authentication status may be visible on a user device such that the second user may show the authentication result to the first user.

In one implementation, an additional authentication process is triggered if an additional user enters the threshold vicinity. In one implementation, authentication processes are triggered until an event preventing access, such as when a machine is locked or powered down, or a door is closed after entry.

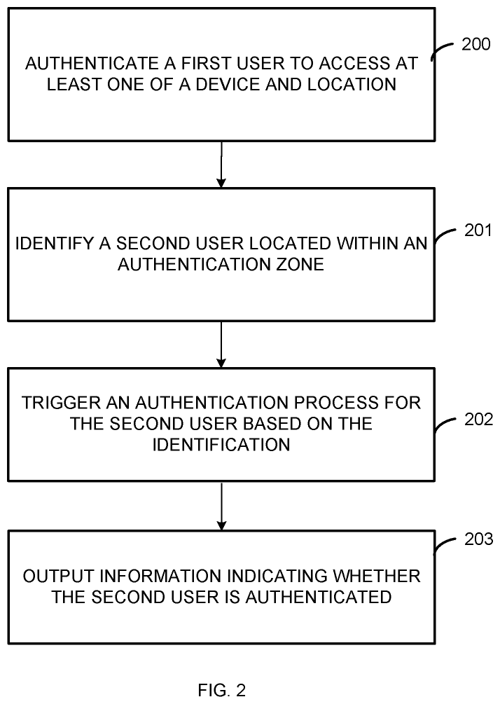

FIG. 2 is a flow chart illustrating one example of a method to authenticate a first and second user. For example, a first and second user may be authenticated in a communal manner such that the access of one user does not automatically allow the access of another user. For example, an authenticated user opening a door may provide access to an unauthenticated user in the vicinity. A communal authentication method may prevent unauthorized access by automatically triggering an authentication process for other users in a vicinity when a first user is authenticated. The method may be implemented, for example, by the computing system 100 of FIG. 1.

Beginning at 200, a processor authenticates a first user to access at least one of a device and location. The device may be any suitable device, such as a piece of equipment or a computing device. The location may be a restricted location guarded with a door, fence, or other mechanism. The authentication process for the first user may be triggered by the user entering a vicinity, scanning a badge, or otherwise requesting access. If the user is positively authenticated, the processor may determine if other users are affected by the access of the first user.

Continuing to 201, a processor identifies a second user located within an authentication zone. The authentication zone may be, for example, a zone where a person may be given access due to the access of the first user. For example, the zone may be in a vicinity to a door that the person would likely reach the door before closing behind the first user. The processor may determine the location of the authentication zone and/or receive information about the location of the authentication zone from a storage. The authentication zone may be related to a specific radius around the location or device to which the first user is authenticated.

The position of the second user may be determined in any suitable manner, such as based on location data received from a device associated with the second user. In one implementation, a camera or other sensor detects the second user without information received directly from the second user.

In one implementation, if the first user is not authenticated, the authentication of additional users is not triggered. In one implementation, the processor receives information indicating that the second user has exited the authentication zone. For example, sensor data from a wearable of the second user may indicate that the user left the authentication zone. In response, the processor may terminate an authentication process related to the second user.

The authentication process of the second user may include any suitable authentication process. For example, the processor may receive information from a device associated with the second user, such as a mobile device, or may capture information related to the user, such as an image of the second user. The processor may compare received information to stored information to determine whether to authenticate the second user.

In one implementation, the first user may provide information used to authenticate the second user. For example, the first user may indicate that the second user is a guest of the first user. In one implementation, the first user may provide name or other identification information in cases where the second user does not have an authenticating item, such as a mobile device or badge. As an example, the first and second user may have wearables for authentication, and the first user may touch his wearable to the wearable of the second user to transmit information that may be used to authenticate the second user.

In one implementation, the processor receives rules related to the authentication of the second user from the first user, such as an authentication time period and/or time limit. For example, the first user may authenticate the second user to enter the restricted area for a particular day that the second user is visiting a facility.

Continuing to 202, a processor triggers an authentication process for the second user based on the identification. The authentication process may be any suitable authentication process, such as an authentication process based on information received from the second user and/or from a device associated with the second user. The processor may compare received information to stored authentication information. In one implementation, the second user is authenticated based on rules for access, such as related to time period, training level, or role. For example, the processor may authenticate the identity of the second user and compare information about the second user to a stored set of authentication rules. The authentication process for the second user may be terminated if the second user exits the authentication zone. In one implementation, the authentication if the first users exits the area without access, the authentication process for additional users is terminated.

Continuing to 203, a processor outputs information indicating whether the second user is authenticated. The processor may store, transmit, and/or display information indicating whether the second user is authenticated.

In one implementation, a wearable or mobile device associated with the first user may generate a notification related to the authentication of the second user. For example, the first user may receive a notification that the second user is or is not authenticated. For example, the notification may indicate to the first user that a user within the authentication zone is not authenticated and that the first user should not allow access. In one implementation, the notification includes a description of a specific user such that the first user may not provide access to the specific user. In one implementation, information about unauthorized users may be output to a device associated with the first user, such as information about the specific user and/or an alert indicating that unauthorized users are in the vicinity.

In one implementation, information about authentication status is displayed on a display device intended to be visible to multiple users within the authentication zone. For example, a digital sign near a door or device may list names or include images of users that are authenticated. In one implementation, authentication information is transmitted to individuals, such as where the second users receives an alert that he is not authenticated. The notification to the second user may provide additional information, such as related to authentication rules not met. For example, the second user may receive a notification that he is not authorized to use equipment X until he completes training A.

In one implementation, the second user receives an authentication notification in a manner that may be used to show other users. For example, a wearable of the second user may have a green light if authenticated and a red light if not authenticated. The wearable may be shown to other users such that they can verify the authentication status of the second user prior to allowing access.

In one implementation, information about the authentication status of other users is output prior to allowing access by the first authenticated user. In one implementation, access to the device and/or location is affected by the authentication status of the second user. For example, a door may not open or equipment may not enable until the second user that is unauthenticated leaves the authentication zone. In one implementation, an alert is issued if an unauthenticated user attempts to access a location or equipment to which he is not authorized, and the alert may be generated in real time based on the stored authentication status information determined when the first user was authenticated.

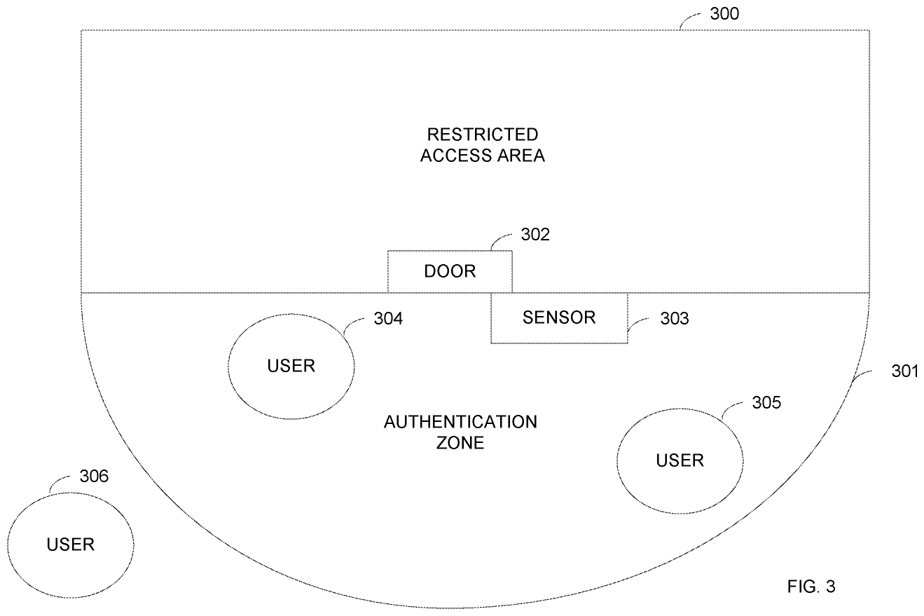

FIG. 3 is a diagram illustrating one example of authenticating a first and second user. FIG. 3 includes a restricted area 300 with access door 302 used to enter and exit the restricted area. An authentication zone 301 surrounds the door 302. A processor may determine and store information about the location of the authentication zone. The authentication zone may be invisible to users. A sensor 303 may be used to identify users within the authentication zone 301. The sensor 303 may be, for example, a Bluetooth beacon. A user 304 may enter the authentication zone 301. An authentication process may be triggered for the user 304, such as in response to an action by the user 304 or by receipt of information from a device associated with the first user 304. If the user 304 is authenticated, a processor may begin a process to receive information from the sensor 303 related to additional users within the authentication zone 301.

The processor may receive information related to the user 305 from a wearable or other device associated with the user 305. In response to detecting the user 305 within the authentication zone and the authentication of the first user, the processor may initiate an authentication process of the user 305. In one implementation, the authentication process involves receiving information from and/or transmitting information to wearable or mobile device of user 305. Information about the status of the authentication of the user 305 may be transmitted to a wearable of the user 304 and/or a wearable of the user 305. An authentication process may not be triggered for user 306 because user 306 is outside of the authentication zone 306.

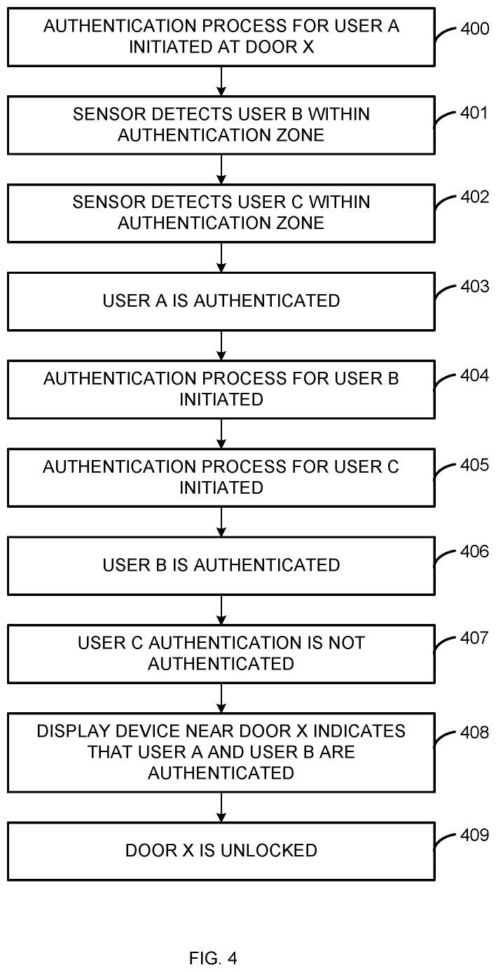

FIG. 4 is a flow chart illustrating one example of authenticating multiple users, such as using the computing system 100 of FIG. 1. An authentication system may trigger authentication processes for users in an authentication zone if a first user is authenticated. Information about the authentication status of each of the users may be provided in a manner such that users within the authentication zone are made aware of the authentication status of other users.

Beginning at 400, an authentication process for user A is initiated at door X. For example, the authentication process may be initiated by an action of user A, such as scanning a badge, or user A may be authenticated automatically by a device associated with user A, such as a wearable device. For example, the wearable device may be a watch or bracelet.

Continuing to 401, a sensor detects user B within an authentication zone. For example, a camera may detect the presence of user B within a threshold distance of door X. In on implementation, a device, such as a wearable device, associated with user B provides information about the location of user B to the sensor.

Continuing to 402, the sensor detects user C within authentication the zone. For example, user C may be detected based on a communication from an electronic device associated with user C. In one implementation, the processor determines users within the authentication zone as users enter and leave the authentication zone such that the processor accesses a stored list of users within the authentication zone when a first user is authenticated.

Continuing to 403, user A is authenticated. For example, information provided by user A or a device associated with user A may be used to authenticate user A. In one implementation, user A is authenticated based on an image of user A captured when user A approaches door X.

Continuing to 404, an authentication process for user B is initiated. For example, an authentication process may be initiated in response to the authentication of user A.

Continuing to 405, an authentication process for user C is initiated. For example, an authentication processor for user C may be initiated in response to the authentication of user A because user C is in an authentication zone, and access of user A may allow access of user C.

Continuing to 406, user B is authenticated. For example, a processor may authenticate user B based on information received from user B, or received from a device associated with user B.

Continuing to 407, the authentication process for user C completes, and users C is not authenticated. For example, user C may not be included in authorized users. In one implementation, a response process is initiated, such as by sending a notification to user C or to a security administrator. In one implementation, user A is not provided access until unauthorized user C exits the authentication zone.

Continuing to 408, display device near door X indicates that user A and user B are authenticated. In one implementation, the display device also provides information indicating that user C is not authenticated. In one implementation, additional notifications are provided to devices associated with the individual users.

Continuing to 409, door X is unlocked. User A may choose not to hold the door open for user C because of the information indicating that user C is not authenticated. In one implementation, the processor causes a device to alert if user C attempts to walk through the door, such as causing a device to issue an audible alert or transmit information to a security department. Authenticating users in a communal manner may decrease the likelihood that an unauthenticated user gains access in conjunction with access of an authenticated user.

1. A computing system, comprising:
a processor to:
authenticate a first user to access at least one of a device and location;
locate a second user within a threshold vicinity of at least one of the first user, the location, and the device;
trigger an authentication process for the second user in response to the authentication of the first user; and
output information indicating whether the second user is authenticated.

2. The computing system of claim 1, where outputting information comprises:
outputting the information to a first device associated with the first user; and
outputting the information to a second device associated with the second user.

3. The computing system of claim 2, wherein the first device and second device comprise at least one of a mobile and wearable device.

4. The computing system of claim 1, wherein the authentication process for the second user comprises authenticating based on information from the first user related to the second user.

5. The computing system of claim 1, further comprising a storage to store authentication rules related to at least one of: user training level, authentication time period, role, and relationship.

6. The computing system of claim 1, further comprising a sensor used to determine the location of the second user.

7. A method, comprising:
authenticating a first user to access at least one of a device and a location;
identifying a second user located within an authentication zone;
triggering, by a processor, an authentication process for the second user based on the identification; and
outputting information indicating whether the second user is authenticated.

8. The method of claim 7, further comprising terminating the triggered authentication process if the second user exits the authentication zone.

9. The method of claim 7, further comprising authenticating the second user based on information from the first user.

10. The method of claim 9, wherein the information from the first user comprises an authentication time period to associated with the second user.

11. The method of claim 9, further comprising generating, by at least one of a wearable and mobile device associated with the first user, a notification related to the authentication status of the second user.

12. The method of claim 7, wherein outputting information indicating whether the second user is authenticated comprises transmitting information indicating whether the second user is authentication to an electronic device to display the authentication information.

13. A machine-readable non-transitory storage medium comprising instructions executable by a processor to:
authenticate users in communal manner, wherein an authentication process for a second user is triggered if the second user is determined to be located within an area associated with a likelihood that access of an authenticated first user provides access to the second user; and
output information about the result of the authentication process for the second user.

14. The machine-readable non-transitory storage medium of claim 13, further comprising instructions to determine accessibility to the second user based on sensor data from a wearable device associated with the second user.

15. The machine-readable non-transitory storage medium of claim 13, wherein instructions to output information comprise instructions to output information to at least one of a mobile and a wearable device.
